(19) United States
(12) Patent Application Publication
(10) Pub. No.: US 2009/0103491 A1
(43) Pub. Date: Apr. 23, 2009

(54) LINK LAYER QUALITY OF SERVICE PARAMETER MAPPING

(75) Inventors: Juan Carlos Zuniga, Montreal (CA); Sabeeh A. Siddiqui, Montreal (CA)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 12/134,376

(22) Filed: Jun. 6, 2008

Related U.S. Application Data
(60) Provisional application No. 60/943,159, filed on Jun. 11, 2007.

(51) Int. Cl. H04W 36/30

(52) U.S. Cl. 370/331

(57) ABSTRACT

A detailed QoS parameter mapping of 3GPP QoS parameters to IEEE 802.21 MIH link QoS parameters. The detailed mapping includes an IEEE 802.21 Supported Number of Class of Service (CoS) parameter to indicate supported 3GPP QoS classes (conversational, streaming, interactive, and background). IEEE 802.21 MIH capable networks may use the detailed mapping to improve access-independent mobility management. A wireless transmit/receive unit (WTRU), an access point, and other network infrastructure capable of performing the detailed QoS parameter mapping are also disclosed.

### CROSS REFERENCE TO RELATED APPLICATIONS

This application claims the benefit of U.S. provisional application No. 60/943,159 filed on Jun. 11, 2007, which is incorporated by reference as if fully set forth.

### TECHNICAL FIELD

The disclosed subject matter relates to wireless communications. In particular, it relates to mapping of link layer quality of service (QoS) parameters.

### BACKGROUND

The IEEE 802.21 Media Independent Handover (MIH) standard defines mechanisms and procedures that aid in the execution and management of inter-access technology mobility management. IEEE 802.21 defines three main services available to Mobility Management applications. Referring to FIG. 1, these services are the Event Service 100, the Information Service 105 and the Command Service 110. These services aid in the management of handover operations, system discovery and system selection by providing information and triggers from lower layers 115 to upper layers 120, and lower layer commands from upper layers 120 to lower layers 115 via a media independent handover function (MIHF) 125. While FIG. 1 shows MIHF 125 as a middle layer in a protocol stack, MIHF 125 may also be implemented as an MIH plane that is capable of exchanging information and triggers directly with each and every layer of a technology specific protocol stack.

Events may indicate changes in state and transmission behavior of the physical, data link and logical link layers, or predict state changes of these layers. The Event Service 100 may also be used to indicate management actions or command status on the part of the network or a management entity. The command service 110 enables higher layers to control the physical, data link, and logical link layers (referred to collectively as lower layers). The higher layers may control the reconfiguration or selection of an appropriate link through a set of handover commands. If a MIHF supports the command service, all MIH commands are mandatory in nature. When an MIHF receives a command, it is always expected to execute the command. The Information Service 105 provides a framework and corresponding mechanisms by which a MIHF entity may discover and obtain network information existing within a geographical area to facilitate handover.

IEEE 802.21 also provides a uniform set of functionalities that help enable and enhance media independent handovers across different link-layer technologies. IEEE 802.21 defines a Quality of Service (QoS) parameter which provides a qualitative measure of the performance of a specific link-layer technology; such as transfer speed (throughput), packet transfer delay, packet loss, and the like.

Currently IEEE 802.21 has defined a mapping table comprised of the IEEE 802.21 defined QoS link parameters and the corresponding QoS link parameters of various link-layer technologies including IEEE 802.16, 3GPP, and 3GPP2. Each link-layer technology therefore has a specific set of QoS parameters that differ from the IEEE 802.21 QoS parameters and each other.

Table 1 shows an example service link parameter mapping across various radio access technologies. By way of example, IEEE 802.21 QoS parameters are mapped to IEEE 802.16 and 3GPP QoS parameters. The current IEEE 802.21 standard parameter mapping lacks sufficient detail for providing a reasonable and 3GPP-equivalent QoS over non-3GPP technologies.

TABLE 1

| | 802.21 Link QoS Parameters | | |
|---|---|---|---|
| | 802.16 | 3GPP | 3GPP2 |
| Throughput | Maximum | Maximum | Peak_Rate |
| | Sustained | Bitrate | |
| | Traffic Rate | | |
| Packet Loss Rate | | | Max_IP_Packet_Loss_Rate |
| Packet Error Rate | Packet Error | SDU Error | |
| | Rate | Ratio | |
| CoS Minimum Packet | | | |
| Transfer Delay | | | |
| CoS Average Packet | | Transfer Delay | |
| Transfer Delay | | | |
| CoS Maximum Packet | Maximum | | Max_Latency |
| Transfer Delay | Latency | | |
| CoS Packet Transfer | Tolerated Jitter | | Delay_Var_Sensitive |
| Delay Jitter | | | |

### SUMMARY

A QoS parameter mapping of 3GPP QoS parameters to IEEE 802.21 MIH link QoS parameters for providing 3GPP-equivalent QoS over non-3GPP access technologies is disclosed. The mapping includes an IEEE 802.21 Supported Number of Class of Service (CoS) parameter to indicate supported 3GPP QoS classes (conversational, streaming, interactive, and background). IEEE 802.21 MIH capable networks may use, for example, the mapping to improve access-independent mobility management.

### BRIEF DESCRIPTION OF THE DRAWINGS

A more detailed understanding of the invention may be had from the following description, given by way of example and to be understood in conjunction with the accompanying drawings wherein:

FIG. 1 is an IEEE 802.21 protocol architecture according to the prior art;

FIG. 2 is a flow diagram of a method of mapping 3GPP QoS Parameters contained in a 3GPP information element (IE) to IEEE 802.21 Link QoS Parameters;

FIG. 3 is a flow diagram of a method of mapping IEEE 802.21 Link QoS Parameters to 3GPP QoS Parameters; and

FIG. 4 is a WTRU and access point configured to map 3GPP QoS Parameters and IEEE 802.21 Link QoS Parameters as disclosed herein.

### DETAILED DESCRIPTION

When referred to herein, the terminology “wireless transmit/receive unit (WTRU)” includes but is not limited to a user equipment (UE), a mobile station, a fixed or mobile subscriber unit, a mesh node, a pager, a cellular telephone, a personal digital assistant (PDA), a computer, or any other type of user device capable of operating in a wireless environment. When referred to hereafter, the terminology “access point” (AP) includes but is not limited to a Node-B, a site controller, a base station, or any other type of interfacing device capable of operating in a wireless environment.

To facilitate access-independent mobility management, IEEE 802.21 link QoS parameters are mapped to Third Generation Partnership Project (3GPP) QoS parameters. A WTRU operating in a 3GPP access network (such as a Universal Mobile Telecommunications System (UMTS)) may utilize 3GPP QoS parameters for normal operation and intra-access system mobility. For mobility management with external networks, detailed 3GPP QoS parameters are mapped to IEEE 802.21 link QoS parameters in accordance with Table 2 below. External networks having different QoS parameters may then utilize the IEEE 802.21 link QoS parameters for mobility management, such as inter-system handover, for example. The mapping is bidirectional, meaning IEEE 802.21 link QoS parameters may be mapped to 3GPP QoS parameters, and 3GPP QoS parameters may be mapped to IEEE 802.21 link QoS parameters in accordance with Table 2 below, as the access system architecture and mobility scenario warrants.

TABLE 2

| 802.21 Link QoS | | | | | 3GPP IE |
|---|---|---|---|---|---|
| Parameters | Related 3GPP parameters | | | | Name |
| Supported number | 4 | | | | Quality |
| of CoS: | Conversational | Streaming | Interactive | Background | of Service |
| Throughput | Peak throughput | | | | |
| | Mean throughput | | | | |
| | Maximum bit rate for uplink/downlink | | | | |
| | Guaranteed bit rate for | | | | |
| | uplink/downlink | | | | |
| Link Packet Error | SDU Error Ratio | | | | |
| Rate | Residual Bit Error Rate | | | | |
| CoS Minimum | Transfer delay | | | | |
| Packet Transfer | | | | | |
| Delay | | | | | |
| CoS Average Packet | Transfer delay | | | | |
| Transfer Delay | | | | | |
| CoS Maximum | Maximum transfer delay | | | | |
| Packet Transfer | | | | | |
| Delay | | | | | |
| CoS Packet Transfer | | Delay | | | |
| Delay Jitter | | variation | | | |

| | |
|---|---|
| CoS Packet Loss | Residual Bit Error Rate |
| Rate | SDU Error Ratio |

The IEEE 802.21 link QoS parameters include a supported number of class of service (CoS) parameter, a throughput parameter, a link packet error rate parameter, a CoS packet transfer delay parameter, a CoS average packet transfer delay parameter, a CoS maximum packet transfer delay parameter, a CoS packet transfer delay jitter parameter, and a CoS packet loss rate parameter. The supported number of CoS parameter indicates the maximum number of differentiable classes of service supported. The throughput parameter indicates various metrics associated with a data rate of a communication link. The CoS packet transfer delay parameter indicates the minimum packet transfer delay for all CoS defined as the minimum delay over a class population of interest. The CoS average packet transfer delay parameter indicates the average packet transfer delay for all CoS defined as the arithmetic mean of the delay over a class population of interest. The CoS maximum packet transfer delay parameter indicates the maximum packet transfer delay for all CoS defined as the maximum delay over a class population of interest. The CoS packet transfer delay jitter parameter indicates the packet transfer delay jitter for all CoS defined as the standard deviation of the delay over a class population of interest. The CoS packet loss rate parameter indicates the packet loss rate for all CoS defined as the ratio between the number of frames that are transmitted but not received and the total number of frames transmitted over a class population of interest.

Referring still to Table 2 above, 3GPP QoS parameters are associated with at least one of four 3GPP defined CoS: Conversational, Streaming, Interactive and Background. Certain 3GPP QoS parameters are only associated with one or two CoS. For example, the 3GPP delay variation QoS parameter is only associated with the 3GPP streaming CoS. Of course, many 3GPP parameters are defined and applicable for all four CoS.

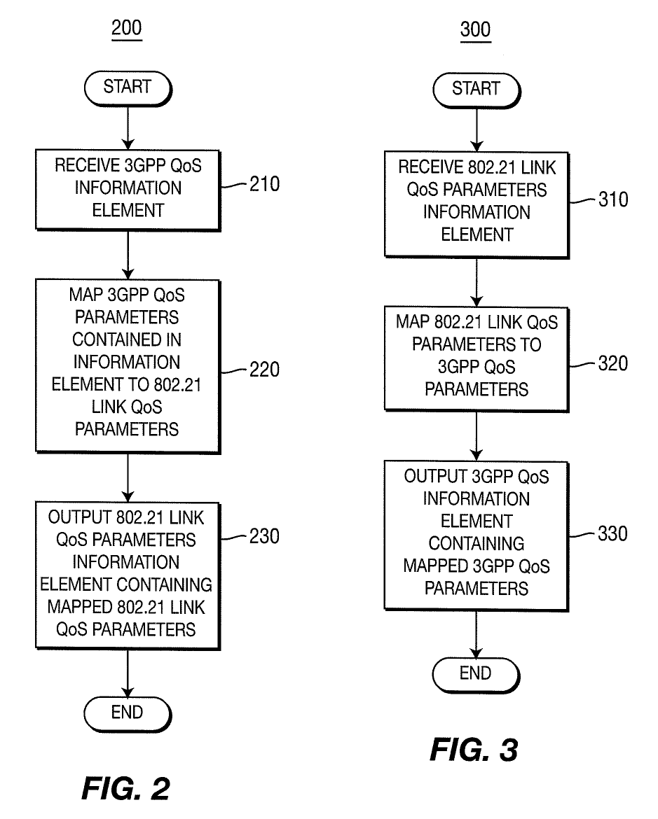

FIG. 2 is a method 200 for mapping 3GPP QoS parameters contained in a 3GPP QoS IE to IEEE 802.21 Link QoS Parameters. First, a mapping entity receives a 3GPP QoS IE, (step 210). The mapping entity then maps the received 3GPP QoS Parameters contained in the 3GPP QoS IE to IEEE 802.21 Link QoS parameters, (step 220). This mapping may be performed in accordance with Table 2 above. Finally, the mapping entity outputs an IEEE 802.21 Link QoS Parameters IE containing the mapped IEEE 802.21 Link QoS Parameters, (step 230). The mapping entity may be any entity, such as a media independent handover function (MIHF) or the like.

FIG. 3 is a method 300 for mapping IEEE 802.21 Link QoS Parameters to 3GPP QoS parameters. First, a mapping entity receives an IEEE 802.21 Link QoS Parameters IE, (step 210). The mapping entity then maps the received IEEE 802.21 Link QoS Parameters contained in the IEEE 802.21 Link QoS Parameters IE to 3GPP QoS Parameters, (step 220). This mapping may be performed in accordance with Table 2 above. Finally, the mapping entity outputs a 3GPP QoS IE containing the mapped 3GPP QoS Parameters, (step 230). The mapping entity may be any entity, such as a media independent handover function (MIHF) or the like.

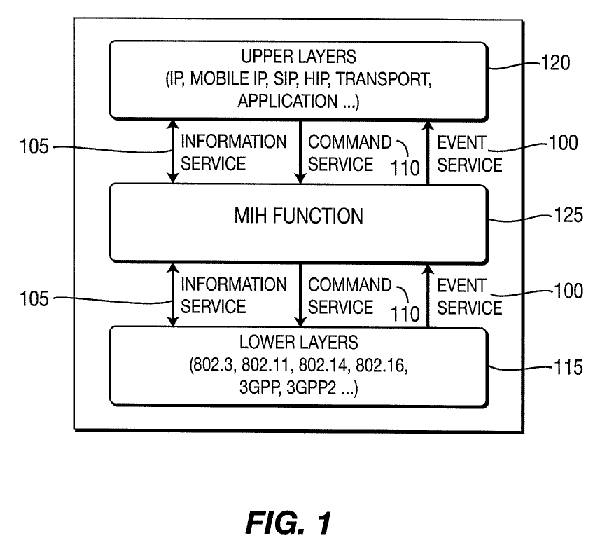

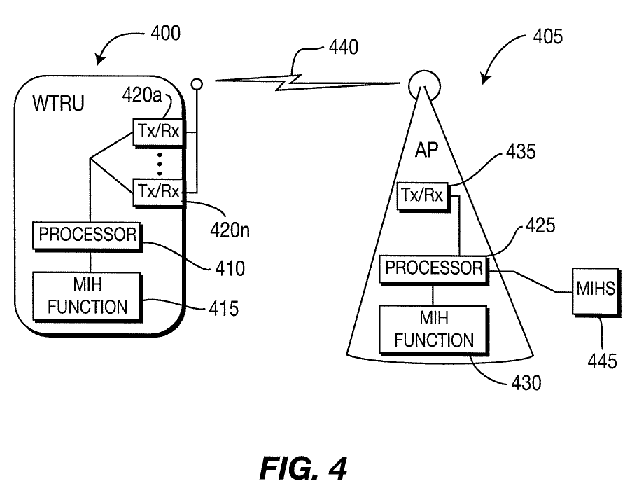

FIG. 4 is a WTRU 400 and access point 405 configured to implement the QoS parameter mapping described herein. WTRU 400 includes a processor 410, an MIH function 415, and a plurality of transceivers 420a . . . 420n, each configured to operate using a different radio access technology and protocol. The processor 410 is configured to operate protocol stacks according to FIG. 1 and the respective access technologies associated with transceivers 420a . . . 420n. Further, the Processor 410 and MIH function 415 are capable of mapping QoS parameters of access technologies to IEEE 802.21 link QoS parameters in accordance with Table 2 above as well as FIGS. 3 and 4.

Access point 405 includes a processor 425, an MIH function 430, and a transceiver 435. The access point 405 communicates with WTRU 400 via air interface 440. WTRU 400 may communicate with a plurality of access points using differing radio access technologies and protocols. The processor 425 of the access point 405 is configured to operate a protocol stacks according to FIG. 1 and typically one lower layer access technology stack, although multiple access technology stacks may be implemented by the access point 405. Further, the Processor 425 and MIH function 430 are capable of mapping QoS parameters of access technologies to IEEE 802.21 link QoS parameters in accordance with Table 2 above as well as FIGS. 3 and 4.

In one embodiment, access point 405 is a 3GPP UMTS base station. WTRU 400 includes a 3GPP UMTS transceiver (one of the plurality of transceivers 420a . . . 420n) for communicating with access point 405 via air interface 440. MIH function 430 of access point 405 is configured to map 3GPP QoS parameters to IEEE 802.21 link QoS parameters in accordance with Table 2 above as well as FIGS. 3 and 4. Mapped parameters may be stored locally at the access point 405 or in an MIH server (MIHS) 445. MIHS 445 may further facilitate mobility management by transferring IEEE 802.21 link QoS parameters to various access networks (independently or responsive to a request).

Although the features and elements of the present invention are described in the preferred embodiments in particular combinations, each feature or element can be used alone without the other features and elements of the preferred embodiments or in various combinations with or without other features and elements of the present invention. The methods or flow charts provided in the present invention may be implemented in a computer program, software, or firmware tangibly embodied in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) module.

What is claimed is:

1. A wireless transmit/receive unit (WTRU) comprising:
a processor configured to receive a third generation partnership project (3GPP) quality of service (QoS) information element including a plurality of 3GPP QoS parameters; and
a media independent handover (MIH) function configured to map the plurality of 3GPP QoS parameters to a plurality of IEEE 802.21 link QoS parameters.

2. The WTRU of claim 1, wherein the processor is further configured to receive an IEEE 802.21 link QoS parameter IE including a plurality of IEEE 802.21 link QoS parameters; and the MIH function is further configured to map the plurality of IEEE 802.21 link QoS parameters to a plurality of 3GPP QoS parameters.

3. A wireless transmit/receive unit (WTRU) comprising:
a media independent handover (MIH) function configured to map a third generation partnership project (3GPP) quality of service (QoS) parameter indicating a conversation QoS class, a streaming QoS class, an interactive QoS class, or a background QoS class with a Supported Number of Class of Service (CoS) IEEE 802.21 Link QoS Parameter.

4. The WTRU of claim 3, wherein the MIH function is further configured to map a peak throughput 3GPP QoS parameter, a mean throughput 3GPP QoS parameter, and a maximum bit rate for uplink/downlink 3GPP QoS Parameter with a throughput IEEE 802.21 link QoS parameter.

5. The WTRU of claim 3, wherein the MIH function is further configured to map a guaranteed bit rate for uplink/downlink 3GPP QoS parameter associated with a conversational QoS class or a streaming QoS class with a throughput IEEE 802.21 link QoS parameter.

6. The WTRU of claim 5, wherein the MIH function is further configured to map a service data unit (SDU) error ratio 3GPP QoS parameter and a residual bit error rate 3GPP QoS parameter with a link packet error rate IEEE 802.21 link QoS parameter.

7. The WTRU of claim 6, wherein the MIH function is further configured to map a transfer delay 3GPP QoS parameter associated with a conversational QoS class or a streaming QoS class with a CoS minimum packet transfer delay IEEE 802.21 link QoS parameter.

8. The WTRU of claim 7, wherein the MIH function is further configured to map a transfer delay 3GPP QoS parameter associated with a conversational QoS class or a streaming QoS class with a CoS average packet transfer delay IEEE 802.21 link QoS parameter.

9. The WTRU of claim 8, wherein the MIH function is further configured to map a maximum transfer delay 3GPP QoS parameter associated with a conversational QoS class of a streaming QoS class with a CoS maximum packet transfer delay IEEE 802.21 link QoS parameter.

10. The WTRU of claim 9, wherein the MIH function is further configured to map a delay variation 3GPP QoS parameter associated with a streaming QoS class with a CoS packet transfer delay jitter IEEE 802.21 link QoS parameter.

11. The WTRU of claim 10, wherein the MIH function is further configured to map a residual bit error rate 3GPP QoS parameter with a CoS packet loss rate IEEE 802.21 link QoS parameter.

12. The WTRU of claim 3, further comprising:
a receiver configured to receive a 3GPP information element containing a plurality of 3GPP QoS parameters, and an IEEE 802.21 IE containing an IEEE 802.21 link QoS parameter.

13. The WTRU of claim 3, further comprising:
a transmitter configured to transmit a 3GPP information element containing a plurality of 3GPP QoS parameters, and an IEEE 802.21 IE containing an IEEE 802.21 link QoS parameter.
